(19) United States
(12) Patent Application Publication
(10) Pub. No.: US 2018/0240203 A1
(43) Pub. Date: Aug. 23, 2018

(54) SYSTEM AND METHOD FOR PROVIDING VIRTUAL PRIVACY TAG

(71) Applicant: PANASONIC INTELLECTUAL PROPERTY MANAGEMENT CO., LTD., Osaka (JP)

(72) Inventors: John CRONIN, Bonita Springs, FL (US); Jonathan T. GOGUEN, Brookline, NH (US); Joseph BODKIN, South Burlington, VT (US); Kota MORISAKI, Arlington, VA (US)

(73) Assignee: PANASONIC INTELLECTUAL PROPERTY MANAGEMENT CO., LT D., Osaka (JP)

(21) Appl. No.: 15/437,795

(22) Filed: Feb. 21, 2017

(51) Int. Cl. G06Q 50/12; G06Q 10/06; H04N 9/31

(52) U.S. Cl. CPC G06Q 50/12; H04L 67/12; H04N 9/3129; G06Q 10/063114

(57) ABSTRACT

A system and method for providing a virtual privacy tag includes requesting for service using a guest device. The service requested is stored in the guest device and transmitted to a server for processing. The server in receipt of the service request extracts a room number of a guest room associated with the service request. The server determines a room status based on the request for service. The extracted room number and the determined room status is transmitted to a display device. The display device displays the room status for the guest room.

### BACKGROUND

### 1. Field of the Disclosure

The present disclosure relates to the field of hotel management. More particularly, the present disclosure relates to providing more flexibility for indicating an occupancy status of a guest room and managing of resources based on the indicated occupancy status.

### 2. Background Information

Various theme parks may include on-site hotels for convenience of visitors of the theme parks. Guests of the hotels being occupied with making trips to the theme parks for enjoyment of their children may not often pay much attention to paper privacy tags offered in guest rooms of the hotels. Although hotel management, including hospitality services may benefit greatly from accurate communication of occupancy status of a guest room, paper privacy may not be used accurately or with care. Further, because conventional privacy tags are nothing more than a paper door hanger, it may be easily be removed or subject to being lost.

### BRIEF DESCRIPTION OF THE DRAWINGS

FIG. 1 shows an exemplary general computer system that includes a set of instructions for electronic routing of information, according to an aspect of the present disclosure;

FIG. 2 shows an exemplary system for providing a virtual privacy tag, according to an aspect of the present disclosure;

FIG. 3 shows an exemplary system for displaying a virtual privacy tag, according to an aspect of the present disclosure;

FIGS. 4A-4B show exemplary display apparatuses for displaying a virtual privacy tag, according to aspects of the present disclosure;

FIG. 5 shows an exemplary apparatus for applying a virtual privacy tag, according to an aspect of the present disclosure;

FIG. 6 shows an exemplary hospitality apparatus for scheduling guest services, according to an aspect of the present disclosure;

FIG. 7 shows an exemplary process for providing a virtual privacy tag, according to an aspect of the present disclosure;

FIG. 8 shows an exemplary process for providing a secure mode for a virtual privacy tag, according to an aspect of the present disclosure;

FIG. 9 shows an exemplary process for managing hotel resources based on a location of a guest, according to an aspect of the present disclosure;

FIG. 10 shows an exemplary process for managing hotel resources based on a location of a guest, according to an aspect of the present disclosure; and

FIG. 11 shows an exemplary process for controlling a display device to display a room status, according to an aspect of the present disclosure.

### DETAILED DESCRIPTION

In view of the foregoing, the present disclosure, through one or more of its various aspects, embodiments and/or specific features or sub-components, is thus intended to bring out one or more of the advantages as specifically noted below.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods. Further, any reference to claim elements in the singular, for example, using the articles “a,” “an” or “the”, is not to be construed as limiting the element to the singular.

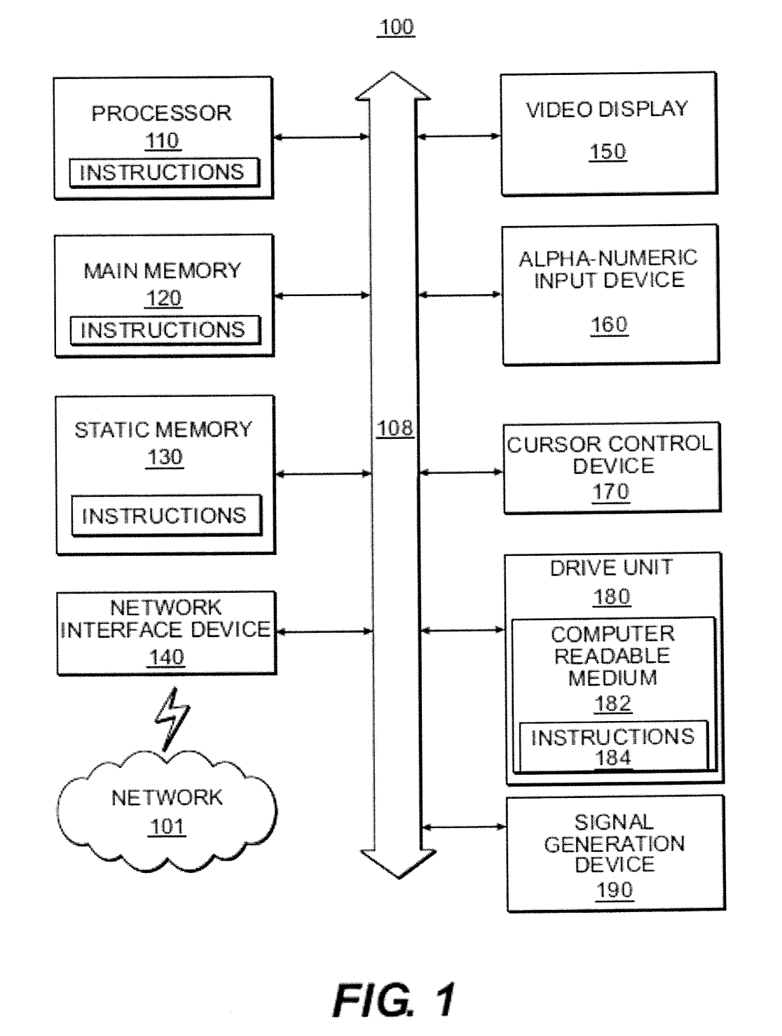

FIG. 1 is an illustrative embodiment of a general computer system, on which a method of electronic routing of information can be implemented, and which is shown and is designated 100. The computer system 100 can include a set of instructions that can be executed to cause the computer system 100 to perform any one or more of the methods or computer based functions disclosed herein. The computer system 100 may operate as a standalone device or may be connected, for example, using a network 101, to other computer systems or peripheral devices.

In a networked deployment, the computer system 100 may operate in the capacity of a server or as a client user computer in a server-client user network environment, or as a peer computer system in a peer-to-peer (or distributed) network environment. The computer system 100 can also be implemented as or incorporated into various devices, such as a stationary computer, a mobile computer, a personal computer (PC), a laptop computer, a tablet computer, a wireless smart phone, a set-top box (STB), a personal digital assistant (PDA), a global positioning satellite (GPS) device, a communications device, a control system, a camera, a web appliance, a network router, switch or bridge, virtual reality system, augmented reality system, a sensor, and monitor, or any other machine capable of executing a set of instructions (sequential or otherwise) that specify actions to be taken by that machine. The computer system 100 can be incorporated as or in a particular device that in turn is in an integrated system that includes additional devices. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 includes a processor 110. A processor for a computer system 100 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. A processor is an article of manufacture and/or a machine component. A processor for a computer system 100 is configured to execute software instructions in order to perform functions as described in the various embodiments herein. A processor for a computer system 100 may be a general purpose processor or may be part of an application specific integrated circuit (ASIC). A processor for a computer system 100 may also be a microprocessor, a microcomputer, a processor chip, a controller, a microcontroller, a digital signal processor (DSP), a state machine, or a programmable logic device. A processor for a computer system 100 may also be a logical circuit, including a programmable gate array (PGA) such as a field programmable gate array (FPGA), or another type of circuit that includes discrete gate and/or transistor logic. A processor for a computer system 100 may be a central processing unit (CPU), a graphics processing unit (GPU), or both. Additionally, any processor described herein may include multiple processors, parallel processors, or both. Multiple processors may be included in, or coupled to, a single device or multiple devices.

Moreover, the computer system 100 includes a main memory 120 and a static memory 130 that can communicate with each other via a bus 108. Memories described herein are tangible storage mediums that can store data and executable instructions, and are non-transitory during the time instructions are stored therein. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. A memory described herein is an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted.

As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an input device 160, such as a keyboard/virtual keyboard or touch-sensitive input screen or speech input with speech recognition, and a cursor control device 170, such as a mouse or touch-sensitive input screen, pad, augmented reality input device, visual input device, video input device, 3D input device, human eye position input device, haptic input device, body tracking device, acoustic tracking device, or a data glove. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g. software, can be embedded. Sets of instructions 184 can be read from the computer-readable medium 182. Further, the instructions 184, when executed by a processor, can be used to perform one or more of the methods and processes as described herein. In a particular embodiment, the instructions 184 may reside completely, or at least partially, within the main memory 120, the static memory 130, and/or within the processor 110 during execution by the computer system 100.

In an alternative embodiment, dedicated hardware implementations, such as application-specific integrated circuits (ASICs), programmable logic arrays and other hardware components, can be constructed to implement one or more of the methods described herein. One or more embodiments described herein may implement functions using two or more specific interconnected hardware modules or devices with related control and data signals that can be communicated between and through the modules. Accordingly, the present disclosure encompasses software, firmware, and hardware implementations. Nothing in the present application should be interpreted as being implemented or implementable solely with software and not hardware such as a tangible non-transitory processor and/or memory.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

The present disclosure contemplates a computer-readable medium 182 that includes instructions 184 or receives and executes instructions 184 responsive to a propagated signal; so that a device connected to a network 101 can communicate voice, video or data over the network 101. Further, the instructions 184 may be transmitted or received over the network 101 via the network interface device 140.

The present disclosure employs a distributed architecture to continuously monitor wait times at attractions as well as a visitor's current location. When a wait time at a visitor's intended attraction exceed a pre-determined threshold, the combination of hardware and software components interact to calculate an attraction closest to the present location of the visitor's location and/or route that most closely matches the interests of the visitor. Furthermore, the combination of hardware components may identify an incentive, based upon a stored profile of the visitor that would be most likely to succeed in motivating the visitor to alter their intended route. In doing so, ride condition, wait times, and visitor location are constantly monitored to determine accurate wait times. Thus, an on the fly minimization of visitor wait times may be achieved.

Furthermore, the distributed architecture enables load distribution, reducing congestion and bottlenecks, while still allowing the data to be accessible from a central location.

As a result, venue operators and managers can route visitors away from attractions that the visitors have expressed an interest in visiting when the current estimated wait time is too great, and route the visitors to alternate attractions that match the interests of the visitors but have shorter wait times. Therefore, the overall satisfaction with the experience is increased.

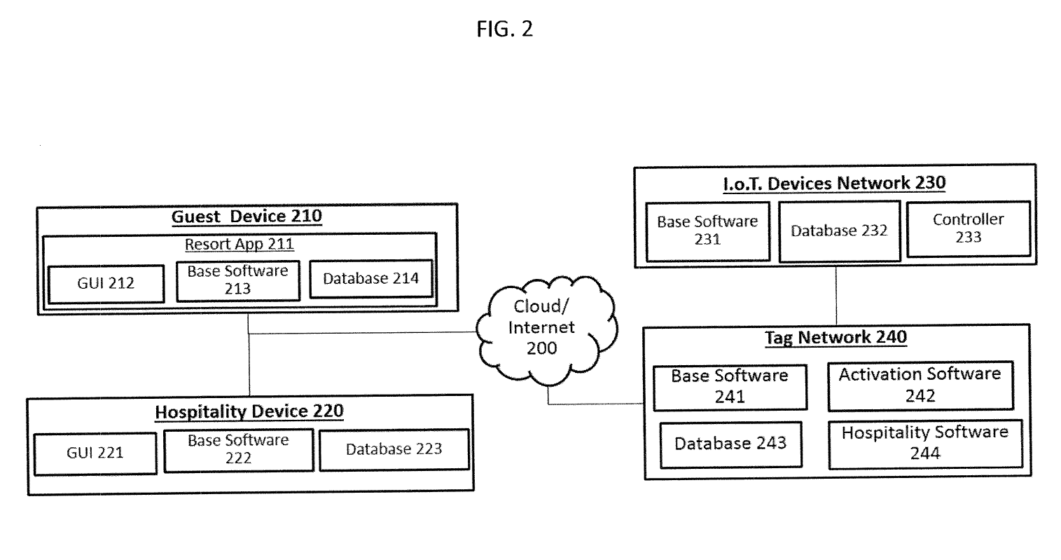

FIG. 2 shows an exemplary system for providing a virtual privacy tag, according to an aspect of the present disclosure.

The exemplary system for providing a virtual privacy tag includes a cloud/internet network 200, a guest device 210, a hospitality device 220, an IoT (Internet of Things) Devices Network 230, and a tag network 240. The guest device 210 may download a resort application 211, which may be provided by the hotel or available at an app store. The resort application 211 includes a GUI 212, base software 213 and a database 214. The hospitality device 220 includes a GUI 221, base software 222, and a database 223. IoT Devices Network 230 may be a server or a system of servers, and include base software 231, a database 232, and a controller 233. The tag network 240 includes base software 241, activation software 242, a database 243, and hospitality software 244.

The system may be initiated when a guest activates a resort application 211 on the guest device 210. Although not explicitly illustrated, the guest device 210 may be an electronic communication device having a processor, a memory, one or more transmitters, and one or more receivers. The guest device 210 may be configured to receive and transmit various forms of communication, including but not limited to Bluetooth®, RFID, GPS, NFC, Wi-Fi, and/or cellular network. The guest device 210 may be a smart phone, a mobile computing device, a wearable electronic device (e.g., fitness level monitoring device).

In example, the guest may initiate the base software 213 by inputting guest options into the GUI 212. The provided inputs may be stored in the database 214. Information stored in the database 214 may be transmitted to the tag network 240 via the cloud/internet 200.

The tag network 240 includes base software 241, activation software 242, a database 243 and hospitality software 244. The information transmitted by the guest device 210 may be received by the base software 241 and stored in the database 243. The activation software 242 may extract a room number of the guest and may receive, when provided by the guest device 210, a hospitality request signal for requesting hospitality service (e.g., housekeeping required, do not disturb, or the like). When the activation software 242 receives a hospitality request signal, the activation software 242 may request the IoT devices network 230 to display a corresponding signal on or near an entry way of a guest room.

More specifically, the base software 231 of the IoT devices network 230 may receive the hospitality request signal, and the database 232 may store the hospitality request signal. Once stored, the hospitality request signal may be transmitted to the controller 233 for controlling an IoT device to display a room status, such as an occupancy or request status, on or near an entry point of a guest room. For example, the IoT devices network 230 may use an IoT projector to project the occupancy or request status on or near the entry point. However, aspects of the present disclosure are not limited thereto, such that the controller 233 may control other IoT devices to display a room status. For example, the controller 233 may control a different IoT enabled display device, such as an LED display, an OLED display, a colored light, a light pattern, a combination thereof, and the like.

Although example of an occupancy or request status is provided as examples of a room status, aspects of the present disclosure are not limited thereto, such that the room status may also include room service status, which may include dinner menu selections, specific requests for certain items (e.g., extra towels, forks and etc.), cleaning service, dry cleaning service, and the like. Further, the room status may be configurable by the guest or the hospitality management to reflect special circumstances.

Further, the room number and the hospitality request signal may also be extracted from the database 243 by the hospitality software 244. The extracted information is then transmitted to the hospitality device 220. The received information (i.e., room number and hospitality request) may be received through the base software 222, stored in the database 223, and displayed through the GUI 221.

Once a hospitality staff member has completed providing of the requested hospitality request, the hospitality staff member may indicate completion of the requested service on the GUI 221. The completion signal is then stored in the database 223, and transmitted to the hospitality software 244.

Once the hospitality software 244 receives the completion signal, the hospitality software 244 relays the information to the base software 231 of the IoT devices network 230. The base software 231 stores the received completion signal in the database 232, and transmits the completion signal to the controller 233. The controller 233 in receipt of the completion signal may correspondingly modify the status of the guest room.

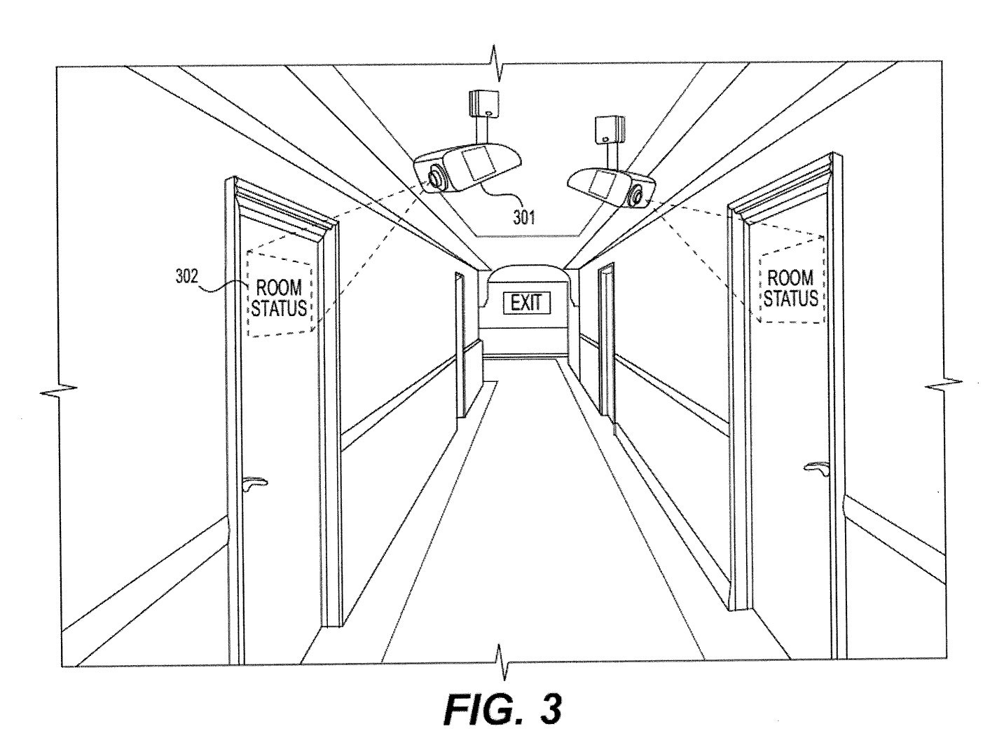

FIG. 3 shows an exemplary system for displaying a virtual privacy tag, according to an aspect of the present disclosure.

As illustrated in FIG. 3, room status 302 may be projected onto a door of a guest room, by an IoT projector 301, in accordance with a request signal transmitted by a guest and/or a signal transmitted by a hospitality staff member. A guest device may transmit a request signal to a tag network, which may retrieve a corresponding room number, and the tag network may transmit both the room number to an IoT network to control the IoT projector 301 assigned to the room number of the guest to display an occupancy status corresponding to the request signal. Further, the IoT projector 301 may be controlled to display the occupancy status in accordance with one or more conditions specified by the guest device. For example, if the guest device specifies that the guest room is to be in a secure mode, the IoT projector 301 may be operated only in presence of an authorized device. More specifically, if the IoT projector 301 detects that a hospitality staff device (e.g., electronic badge, hospitality cart, electronic computing device and etc.) configured to transmit a communication signal is within a predetermined distance from the guest room, an appropriate room or occupancy status may be displayed.

Further, room or occupancy status may be automatically modified in accordance with a location of the guest. For example, if the guest is determined to be at least an hour away from the hotel as determined by a GPS signal of the guest device, the room or occupancy status may be automatically updated to notify the hospitality staff that the guest room is free to clean. However, aspects of the present disclosure are not limited thereto, such that no status may be displayed if the guest requests such information to be hidden from the public. In this case, only the hospitality staff member may be aware of the room or occupancy status of the guest room.

In an example, the IoT projector 301 may be a miniaturized projector that may receive control signal through internet without requiring heavy wiring. Further, the IoT projector 301 may be hardwired to receive power or may be powered by a battery. Versatility of the IoT projector 301 may allow flexible placement. However, aspects of the present disclosure are not limited thereto, such that IoT projection 301 may receive power through a wired source.

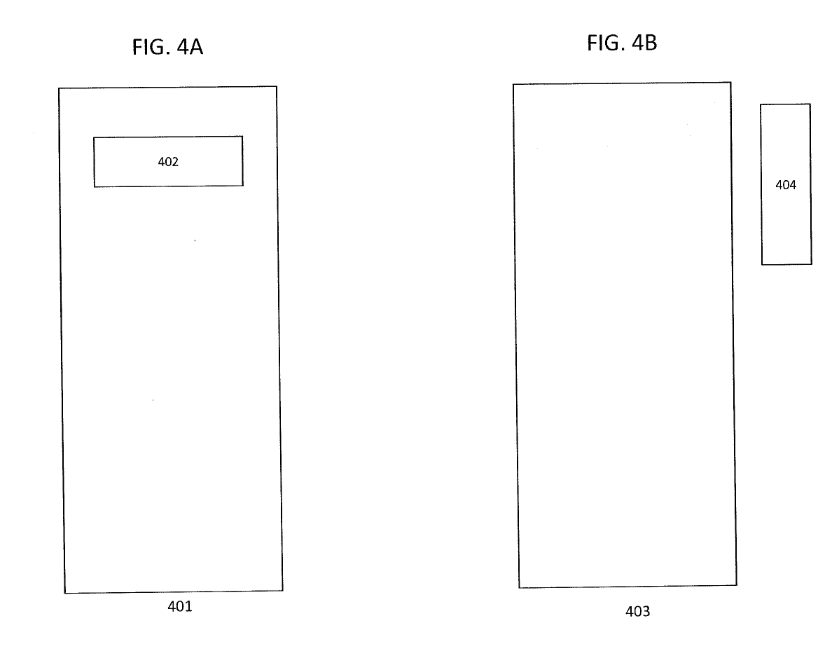

FIGS. 4A-4B show exemplary display apparatuses for displaying a virtual privacy tag, according to aspects of the present disclosure.

The display of room or occupancy status may also be provided by various display devices. As illustrated in FIG. 4A, an electronic display device 402 may be attached onto a door 401 to provide a display of the room or occupancy status. In addition to or alternatively, an electronic display device 404 may be attached onto a wall near a door 403. The electronic display device 402 or 404 may be an IoT enabled LED/OLED display panel, a colored light, or a pattern of lights capable of receiving internet signals. Internet signals may be provided through a wired network, a wireless network, Wi-Fi or any other suitable networks.

Although FIGS. 4A and 4B illustrate that the electronic display devices 402 and 404 are independently utilized, aspects of the present disclosure is not limited thereto, such that the electronic display devices 402 and 404 may be utilized together. In an example, the electronic display device 402 may be an IoT LED display that displays a particular request and the electronic display device 404 may be a colored light (e.g., green) indicating a particular occupancy status. Further, the electronic display device 402 and/or 404 may be used in conjunction with or as an alternative to an IoT projector.

The electronic display devices 402 or 404 may be powered by a battery or other portable power sources. However, aspects of the disclosure are not limited thereto, such that the electronic display devices 402 or 404 may be hardwired to receive power or may be powered by renewable energy, such as solar light. The electronic display devices 402 or 404 may be preferable in environments where hall lighting may be too bright to effectively display a projected image.

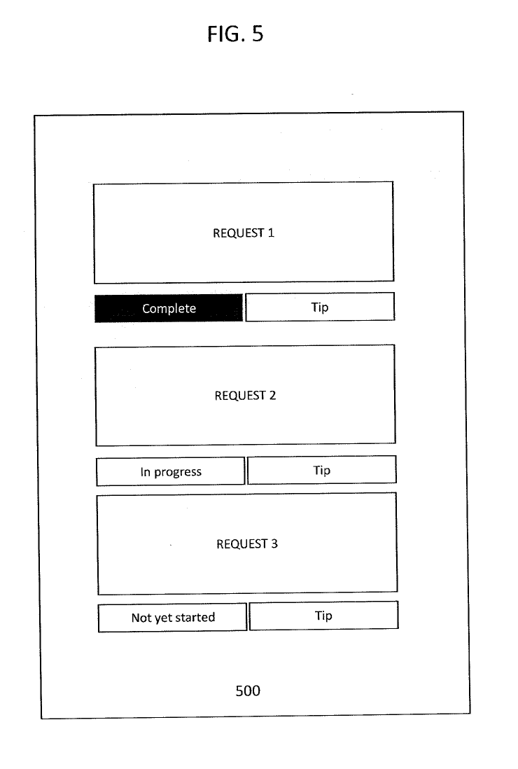

FIG. 5 shows an exemplary apparatus for applying a virtual privacy tag, according to an aspect of the present disclosure.

As illustrated in FIG. 5, a guest device 500 may display various requests that may be made regardless of location of the guest. For example, at least because the guest device 500 may be configured to transmit and receive network signals, a guess may request hospitality service to be performed when the guest is at a theme park. Accordingly, a guest is not required to place the privacy tag prior to leaving the guest room to request a service or request the room not to be disturbed. In an example, hospitality requests may include request for cleaning, request for dry cleaning, request for towel service, request not to be disturbed, and the like.

Upon completion of servicing, an indication may be displayed on the guest device 500 with respect to a request made, such as Request 1. Further, the guest may have an option to tip the hospitality staff member for the services rendered at any time during the hotel stay by pressing on a tip button related to the completed service. Further, if desired, the guest may tip during servicing or before being serviced.

Further, when the guest transmits a request not to be disturbed, entry code to the guest room may be altered such that only the guest is allowed entry to the guest room, thereby preventing any hospitality staff members from obtaining unauthorized entry to the guest room.

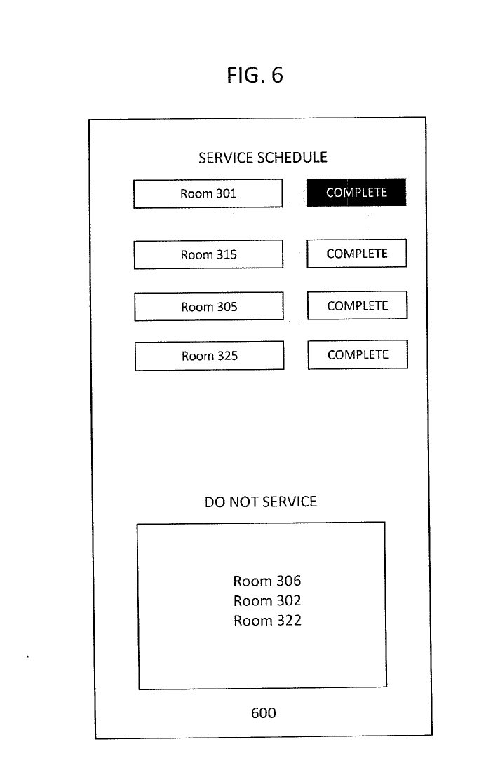

FIG. 6 shows an exemplary hospitality apparatus for scheduling guest services, according to an aspect of the present disclosure.

A hospitality device 600 may display a list of rooms that are scheduled for service according to an occupancy or room status of a guest room. In an example, service schedule for the rooms may be displayed in accordance with vacancy time. In FIG. 6, Room 315 is displayed as being scheduled to be cleaned prior to Room 305. If a guest in Room 315 leaves the guest room at 9:00 AM but a guest in Room 305 does not leave the guest room until 1:30 PM, Room 315 may be scheduled to be cleaned earlier than Room 305 to increase the likelihood that the Room 315 is cleaned before its guest returns. However, aspects of the present disclosure may not be limited thereto, such that guest rooms may be cleaned in accordance with hospitality management policies.

Further, once a guest room has been serviced, the hospitality staff member may press the complete button to indicate a completion of service.

In addition, guest rooms requesting no services are listed for the hospitality staff member. The hospitality staff member may rely on this information when the room status or occupancy status is in a secure mode, such that no status is displayed on the door of the guest room itself.

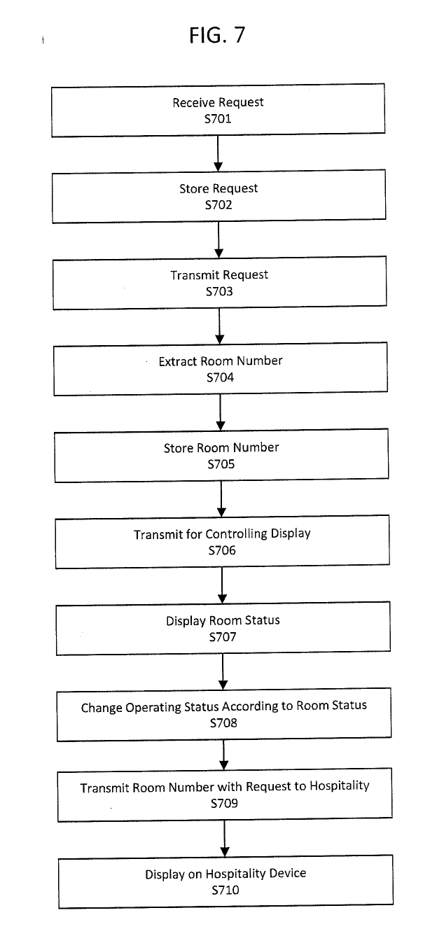

FIG. 7 shows an exemplary process for providing a virtual privacy tag, according to an aspect of the present disclosure.

In S701, a request for service is detected on a guest device. The guest device may be a smart phone, a mobile computing device, a wearable electronic device or the like. The request for service may be made using a resort application corresponding to the hotel the guest is staying at. The resort application may be provided through a hotel Wi-Fi or downloaded at an app store. In S702, the request may be stored in a memory of the guest device.

In S703, the request is transmitted from the guest device to a tag network system. The tag network system may be included in a single server or may be system of servers. In S704, the tag network system extracts the request and corresponding guest room number for servicing. In S705, the tag network system stores the extracted room number and the requested service in its memory.

In S706, the extracted room number and the requested service is transmitted to a controller. In S707, the controller identifies a display device corresponding to the extracted room number and displays a room status or occupancy status corresponding to the requested service. For example, if the requested service is housekeeping service, “housekeeping service requested” may be displayed on the guest room door. In another example, if the requested service is in-room dining service, food selections may be displayed to allow a hospitality staff member to verify the order before delivering to the guest. The display may be kept on until a service has been rendered by the hospitality staff member, such that servicing of a room may not unintentionally be omitted. However, aspects of the present disclosure are not limited thereto, such that the display may be conditionally displayed according to a location of a hospitality member rendering the requested service. The location of the hospitality member may be determined according to a detection of a sensor or device accompanying the hospitality staff member. In another example, if the requested service is a request not to be disturbed, “do not disturb” may be displayed on the guest room door. In addition, key code to the guest room may be altered to bar entry by anyone other than the guest.

Further, if the display device is an IoT projector, the IoT projector may be controlled to project the room or occupancy status onto a door of the guest room according to a door position. For example, if the IoT projector determines that the door is being opened to be in an open position, the IoT projector may be controlled to be shut off such that a display is not shining at the guest that may be opening the door. The movement of the door may be detected using a distance sensor, a movement sensor, or any other suitable technology. In addition, the IoT projector may be controlled to be turned off, at least the display function thereof, according to a signal received from the guest device or a device of a hospitality staff member. Also, the IoT projector may be controlled to be turned off in response to a detection of scanning of an electronic key. In this example, the electronic key may be an IoT device triggering the signal to turn off the IoT projector. Alternatively, the electronic lock to the guest room may be an IoT device that triggers the signal to turn off the IoT projector.

Further, if the guest device sets the guest room to be in a secure mode, an IoT display device may be controlled to display the occupancy status according to a specific condition. For example, the IoT display device may transmit a pilot signal continuously or at predetermined intervals. If a hospitality device detects the pilot signal and transmits a response signal, the IoT display device may be trigger to display the room or occupancy status. If the IoT display device determines that the hospitality device is no longer detectable or no longer provides a response signal, the IoT display device may be turned off. In an example, the hospitality device may be a mobile computing device, a communication device, an electronic badge, a sensor attached to a hospitality equipment (e.g., cart) and the like.

In another example, the IoT display device may be controlled to display the occupancy status according to a signal from an authorized hospitality device. For example, the hospitality device may be a mobile computing device that may operate to trigger the occupancy status to be displayed for a particular room, rooms located at a particular wing of the hotel, or select range of room numbers.

In S708, if it is determined that the guest room is unoccupied, an operating status of the guest room may be modified. For example, HVAC settings may be set in minimum mode and all electrical devices may be shut off to conserve energy. Occupancy status may be determined based on a type of request, originating source of the request, location of the guest device, motion sensing technology, and the like.

In an example, since guests typically do not typically request housekeeping service while they are in the room, request for such service may indicate an unoccupied status. Further, if the request for housekeeping service is requested through a guest device rather than by using a device provided in the guest room, it may be determined that the guest room is unoccupied. In addition, an occupancy status may be determined based on location information of the guest device, which may be provided by a GPS signal.

In S709, the extracted room number and the requested service is also transmitted to a hospitality device for storage. Although not explicitly illustrated, the hospitality device may be an electronic communication device having a processor, a memory, one or more transmitters, and one or more receivers. The hospitality device may be configured to receive and transmit various forms of communication, including but not limited to Bluetooth®, RFID, GPS, NFC, Wi-Fi, and/or cellular network. The hospitality device may be a smart phone, a mobile computing device, a wearable electronic device or the like.

In S710, the extracted room number and the requested service is scheduled for service and displayed on the hospitality device.

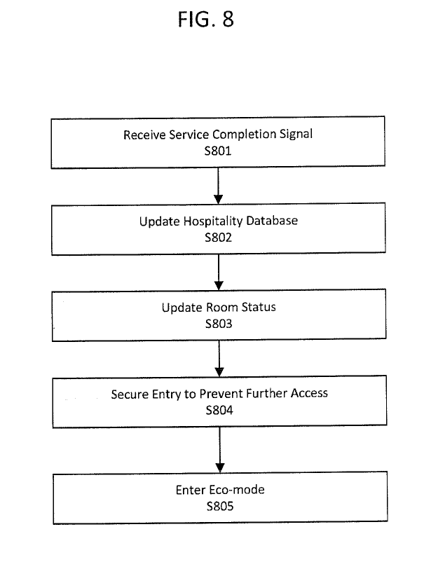

FIG. 8 shows an exemplary process for providing a secure mode for a virtual privacy tag, according to an aspect of the present disclosure.

In S801, a service completion signal is received from a hospitality device. In an example, a hospitality staff member may press a button to trigger a transmission of the completion signal after a service has been rendered. Upon pressing of the button, the button may be highlighted to indicate completion and may be disabled from further operation.

In S802, a database or memory of the hospitality device is updated to indicate the completed status of the requested service. In S803, the completed status information is transmitted to a display device for displaying a completed status of the requested service. In an example, the display device may be an IoT projector configured to project updated room status. In another example, the display device may be an IoT LED/OLED display device.

In S804, upon transmission of the completed status of the requested service and exiting of the guest room, the guest room may automatically enter into a secure mode to prevent further access by hospitality staff member.

In S805, the guest room may also enter into an eco-mode operation to modify its HVAC settings and to shut off electricity to many of the devices in the guest room.

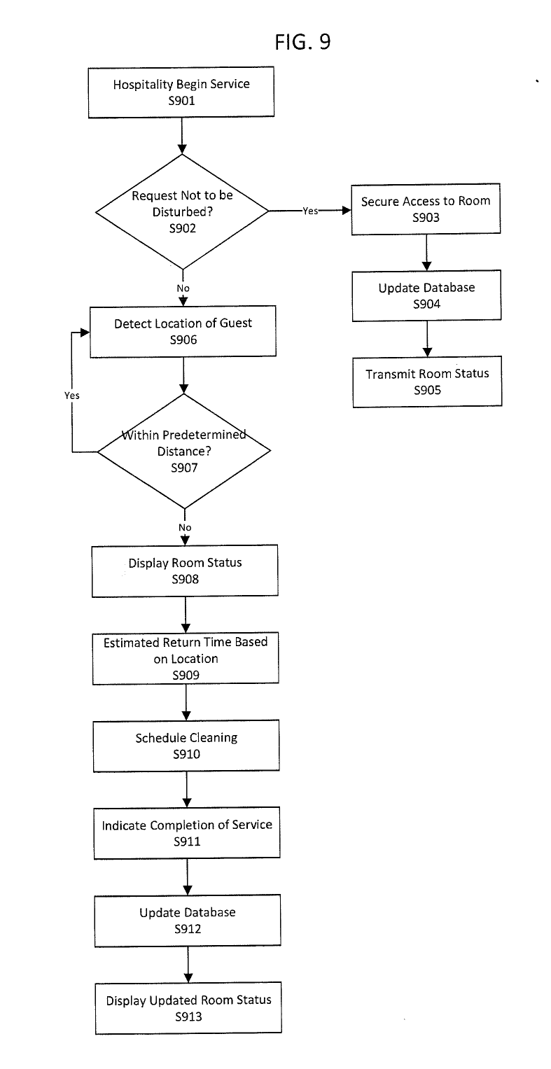

FIG. 9 shows an exemplary process for managing hotel resources based on a location of a guest, according to an aspect of the present disclosure.

In S901, starting of hospitality service is detected. Although hotels may provide some form of hospitality service for 24 hours of the day, certain hospitality services (e.g., housekeeping service) may operate only during certain times of the day for set hours (e.g., 11 AM to 4 PM).

In S902, once the hospitality service is started, a check is made to determine if any of the guest rooms have requested not to be disturbed.

If it is determined that the guest has made a request not to be disturbed, access to the corresponding guest room may be further secured to deny access to the guest room by any hospitality staff member in S903. In an example, additional security feature may be provided by deactivating access keys of the hospitality staff members for guest rooms requesting not to be disturbed.

In S904, the room status or occupancy status is updated in the hospitality device not to service the guest room requesting not to be disturbed.

In S905, the room status or occupancy status is transmitted to an IoT devices network to control a display device to display a corresponding room or occupancy status on a door of the guest room requesting not to be disturbed.

If it is determined that the guest has not made any request not to be disturbed, a location of the guest device is determined in S906. In an example, the location of the guest device may be determined by tracking a GPS signal of the guest device. However, aspects of the present disclosure are not limited thereto, such that the location of the guest device may be determined based on triangulation or other suitable technology. Further, if the hotel is affiliated with another establishment, such as a theme park, a location of a guest may be determined upon ticket purchase or entry to the theme park. For example, upon a ticket purchase, a server from the theme park may notify the affiliated hotel of the ticket purchase. Further, if the guest is issued an electronic tracking device at the theme park, the guest's location may be determined based on the electronic tracking device.

In S907, a determination is made whether the location of the guest device is within a predetermined distance. For example, the predetermined distance may be a distance to an entry point of the hotel or 1 mile from the hotel. If the guest device is determined to be further than the predetermined distance, it may be inferred that the guest has left the hotel premises to attend to other matters. However, if the guest device is determined to be within the predetermined distance, it may be determined that the guest simply went to get some food at a hotel restaurant and has no intention of leaving for an extended period of time.

If it is determined that the guest device is more than predetermined distance away in S907, the room or occupancy status may be set as being unoccupied in S908. The set room or occupancy status may be displayed by a display device corresponding the guest room and on the hospitality device. In an example, if the display device is an IoT projector, the IoT projector may be controlled to project the room or occupancy status onto a door of the guest room according to a door position. If the IoT projector determines that the door is being opened to be in an open position, the IoT projector may be controlled to be shut off such that a display is not shining at the guest that may be opening the door. The movement of the door may be detected using a distance sensor, a movement sensor, or any other suitable technology. In addition, the IoT projector may be controlled to be turned off according to a signal received from the guest device or a device of a hospitality staff member. Also, the IoT projector may be controlled to be turned off in response to a detection of scanning of an electronic key. In this example, the electronic key may be an IoT device triggering the signal to turn off the IoT projector. Alternatively, the electronic lock to the guest room may be an IoT device that triggers the signal to turn off the IoT projector.

However, if the guest has set the occupancy status to be displayed in a secure mode, the room or occupancy status may be displayed on the hospitality device but not on the IoT display device for the guest room as a default. Further, the IoT display device may be controlled to display the occupancy status according to a signal from an authorized hospitality device. For example, the hospitality device may be a mobile computing device that may operate to trigger the occupancy status to be displayed for a particular room, rooms located at a particular wing of the hotel, or select range of room numbers.

Alternatively, if the guest device sets the guest room to be in a secure mode, an IoT display device may be controlled to display the occupancy status according to a specific condition. For example, the IoT display device may transmit a pilot signal at predetermined intervals. If a hospitality device detects the pilot signal and transmits a response signal, the IoT display device may be trigger to display the occupancy status. If the IoT display device determines that the hospitality device is no longer detectable or no longer provides a response signal, the IoT display device may be turned off. In an example, the hospitality device may be a mobile computing device, a communication device, an electronic badge, a sensor attached to a hospitality equipment (e.g., cart) and the like.

In S909, estimated return time may be determined based on the location information of the guest device. For example, if it is determined that the guest device is 20 miles away, it may be determined it will take at least two hours for the guest to arrive back to the hotel. In a different example, if it is determined that the guest device is located at a theme park, it may be determined that the guest will not be back for at least 6 hours.

In S910, hospitality services, such as housekeeping services, may be scheduled according to the estimated return times. For example, even if a first guest leaving for the theme park may have left earlier in the day, if a second guest leaving later in the day expected to return sooner, guest room of the second guest may be scheduled to be serviced earlier than the first guest.

In S911, upon completion of rendering of hospitality services, the hospitality device may indicate a completion of service. In S912, the memory or database of the hospitality device may be updated to reflect the completion of service. In S913, the completion status may be transmitted to a display device for displaying the updated

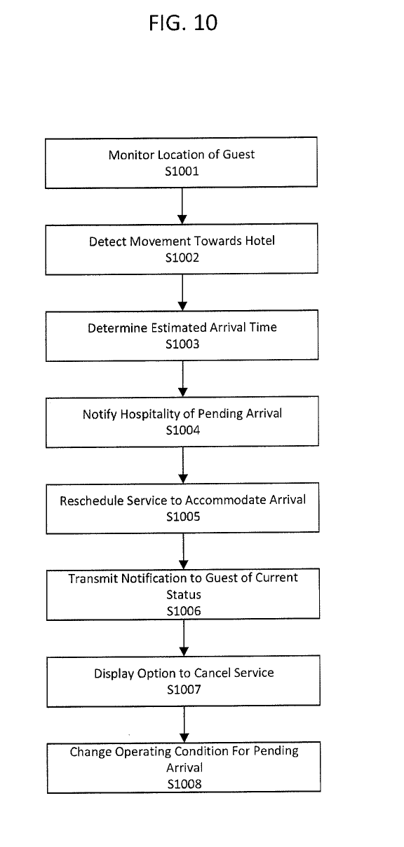

FIG. 10 shows an exemplary process for managing hotel resources based on a location of a guest, according to an aspect of the present disclosure.

In S1001, a location of the guest device is monitored. In an example, the location of the guest device is monitored by tracking its GPS signal.

In S1002, a movement towards the hotel of the guest is detected. In an example, the movement towards the hotel may be required to be at a minimum speed, for minimum duration, or for minimum distance. Further, the movement towards the hotel may be detected only when the guest device is within a predetermined distance from the hotel. Rate of travel speed may be indicated by an accelerometer of the guest device or by a navigation application running on the guest device.

In S1003, a determination of estimated arrival time is made. The estimated arrival time may be determined based on detected rate of travel, speed limit and distance along a path towards the hotel, navigation application and the like.

In S1004, pending arrival of the guest along with expected arrival time is transmitted to the tag network system and the hospitality device.

In S1005, service schedule is updated to accommodate the pending arrival of the guest.

In S1006, current status of the hospitality service may be transmitted to the guest device. In an example, the current status may indicate a service start time and end time.

In S1007, along with the current status, an option is provided to the guest device to cancel rendering of hospitality service.

In S1008, control setting of the guest room is changed to normal mode from an eco-mode for pending arrival of guest. In an example, the control setting may include, without limitation, HVAC settings and electrical connection settings.

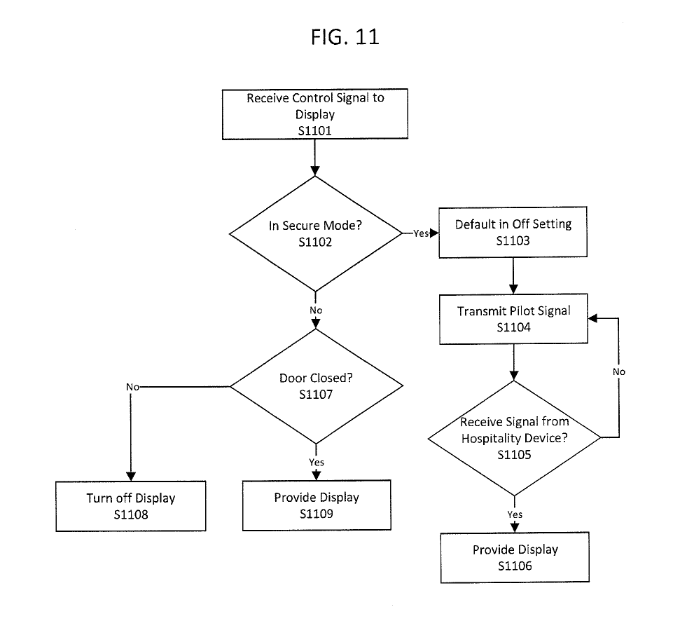

FIG. 11 shows an exemplary process for controlling a display device to display a room status, according to an aspect of the present disclosure.

In S1101, an IoT display device receives a control signal from a controller of an IoT Devices Network to display a room status. In an example, the IoT display device may be a projector, an LED display, an OLED display, a colored light, a patterned light or a combination thereof.

In S1102, a check is made whether the guest room corresponding to the room status to be displayed is set in a secure mode. For example, the secure mode may specify that the room status to be restricted from being displayed unless certain conditions are met, such as receiving a signal from an authorized device.

If it is determined that the secure mode is set to be on in S1102, a display function of the IoT display device remains in an off status in S1103 and does not display the room status.

In S1104, the IoT display device transmits a pilot signal within a predetermined range or distance. Further, the pilot signal may be transmitted continuously or intermittently.

In S1105, the IoT display device checks to determine whether a signal is received from an authorized device, such as a hospitality device. The hospitality device may transmit a signal in response to the pilot signal transmitted by the IoT display device or independent of the pilot signal.

If it is determined that the signal from the hospitality device is not received in S1105, the IoT display device retransmits or continuously transmits the pilot signal in S1104.

If it is determined that the signal is received from the hospitality device in S1105, the IoT display device displays the room status in S1106. In an example, the hospitality device may be a mobile computing device, a communication device, an electronic badge, a sensor attached to a hospitality equipment (e.g., cart) and the like that may transmit a response signal to the pilot signal or an independent signal according to a control operation of the hospitality device.

If it is determined that the guest room is not in the secure mode in S1102, a determination is made whether a door of the corresponding guest room is in a closed position in S1107. In an example, if the display device is an IoT projector, the IoT projector may be controlled to project the occupancy status onto a door of the guest room according to a door position. If the IoT projector determines that the door is being opened to be in an open position, the IoT projector may be controlled to be shut off such that a display is not shining at the guest that may be opening the door. The movement of the door may be detected using a distance sensor, a movement sensor, or any other suitable technology. In addition, the IoT projector may be controlled to be turned off according to a signal received from the guest device or a device of a hospitality staff member. Also, the IoT projector may be controlled to be turned off in response to a detection of scanning of an electronic key. In this example, the electronic key may be an IoT device triggering the signal to turn off the IoT projector. Alternatively, the electronic lock to the guest room may be an IoT device that triggers the signal to turn off the IoT projector.

If it is determined that the door is not in a closed position or otherwise open in S1107, the display function of the IoT display device remains in an off setting in S1108.

Alternatively, if it is determined that the door is in the closed position in S1107, the display function of the IoT display device is switched on to project the room status on the door or display on the IoT display device in S1109.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present specification describes components and functions that may be implemented in particular embodiments with reference to particular standards and protocols, the disclosure is not limited to such standards and protocols.

The illustrations of the embodiments described herein are intended to provide a general understanding of the structure of the various embodiments. The illustrations are not intended to serve as a complete description of all of the elements and features of the disclosure described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

As described above, according to an aspect of the present disclosure, a method is provided for providing a virtual privacy tag. The method includes acquiring, from a guest device, a request for service; storing, in a memory of the guest device, the request for service; transmitting, to a server, the request for service; extracting, by the server, a room number of a guest room corresponding to the request for service; determining, by the server, a room status based on the request for service; transmitting, to a display device, the extracted room number and the room status; and controlling the display device to display the room status for the guest room.

According to another aspect of the present disclosure, the display device is an IoT (internet of things) projector that projects an image of the room status on an entry way of the guest room.

According to yet another aspect of the present disclosure, the display device is a LED (light emitting diode) display panel.

According to still another aspect of the present disclosure, the request for service is made on the guest device and outside of the guest room.

According to another aspect of the present disclosure, the method further includes transmitting, to a hospitality device, the extracted room number and the request for service; and displaying, on the hospitality device, the extracted room number and the request for service.

According to yet another aspect of the present disclosure, the method further includes receiving, from the hospitality device, a completion signal indicating completion of service; transmitting, to the display device, the completion signal; and displaying an updated room status based on the completion signal.

According to still another aspect of the present disclosure, the method further includes altering a locking code for a door of the guest room to prevent further entry by a hotel staff member.

According to another aspect of the present disclosure, the method further includes modifying an operation condition of the guest room for conservation of energy.

According to yet another aspect of the present disclosure, the display device displays the room status when a signal is received from a hospitality device.

According to still another aspect of the present disclosure, the operation condition includes a power setting for one or more electrical devices located in the guest room.

According to an aspect of the present disclosure, the method includes acquiring, from a guest device, location information of the guest device; determining whether the guest device is within a predetermined distance from a hotel registered with the guest device; when the guest device is determined to be further than the predetermined distance, determining a guest room of the guest device to be in an unoccupied state; and setting an operating mode of the guest room to operate in a first mode for conservation of energy based on the unoccupied state of the guest room.

According to yet another aspect of the present disclosure, the method further includes determining an estimated return time based on the location information of the guest device; and switching the operating mode of the guest room to operate in a second mode prior to the estimated return time.

According to still another aspect of the present disclosure, the method further includes determining a service schedule for the guest room based on the estimated return time.

According to another aspect of the present disclosure, the location information indicates that the guest device is at a specific venue.

According to yet another aspect of the present disclosure, the location information indicates that the guest device is at a specific distance away from the hotel.

According to still another aspect of the present disclosure, the method further includes determining an estimated return time based on a movement of the guest device; and switching the operating mode of the guest room to operate in a second mode prior to the estimated return time.

According to another aspect of the present disclosure, the method further includes determining a service schedule for the guest room based on the estimated return time.

According to yet another aspect of the present disclosure, the movement of the guest device indicates that the guest device is within the predetermined distance and moving in a direction towards the hotel.

According to yet another aspect of the present disclosure, the method further includes determining whether the guest device is set to operate in a secure mode; when the guest device is not operating in the secure mode, transmitting the unoccupied state of the guest room to both a hospitality device and a display device for displaying a room status; and when the guest device is operating in the secure mode, transmitting the unoccupied state of the guest room only to the hospitality device among the hospitality device and the display device.

According to an aspect of the present disclosure, a computer apparatus includes a memory that stores instructions, and a processor that executes the instructions. When executed by the processor, the instructions cause the processor to perform operations. The operations include acquiring, from a guest device, a request for service; storing, in a memory of the guest device, the request for service; transmitting, to a server, the request for service; extracting, by the server, a room number of a guest room corresponding to the request for service; determining, by the server, a room status based on the request for service; transmitting, to a display device, the extracted room number and the room status; and controlling the display device to display the room status for the guest room.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The preceding description of the disclosed embodiments is provided to enable any person skilled in the art to make or use the present disclosure. As such, the above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for providing a virtual privacy tag, the method comprising:
acquiring, from a guest device, a request for service;
storing, in a memory of the guest device, the request for service;
transmitting, to a server, the request for service;
extracting, by the server, a room number of a guest room corresponding to the request for service;
determining, by the server, a room status based on the request for service;
transmitting, to a display device, the extracted room number and the room status; and
controlling the display device to display the room status for the guest room.

2. The method of claim 1, wherein the display device is an IoT (internet of things) projector that projects an image of the room status on an entry way of the guest room.

3. The method of claim 1, wherein the display device is a LED (light emitting diode) display panel.

4. The method of claim 1, wherein the request for service is made on the guest device and outside of the guest room.

5. The method of claim 1, further comprising:
transmitting, to a hospitality device, the extracted room number and the request for service; and
displaying, on the hospitality device, the extracted room number and the request for service.

6. The method of claim 5, further comprising:
receiving, from the hospitality device, a completion signal indicating completion of service;
transmitting, to the display device, the completion signal; and
displaying an updated room status based on the completion signal

7. The method of claim 6, further comprising:
altering a locking code for a door of the guest room to prevent further entry by a hotel staff member.

8. The method of claim 6, further comprising:
modifying an operation condition of the guest room for conservation of energy.

9. The method of claim 1, wherein the display device displays the room status when a signal is received from a hospitality device.

10. The method of claim 8, wherein the operation condition includes a power setting for one or more electrical devices located in the guest room.

11. A method for providing a virtual privacy tag, the method comprising:
acquiring, from a guest device, location information of the guest device;
determining whether the guest device is within a predetermined distance from a hotel registered with the guest device;
when the guest device is determined to be further than the predetermined distance, determining a guest room of the guest device to be in an unoccupied state; and
setting an operating mode of the guest room to operate in a first mode for conservation of energy based on the unoccupied state of the guest room.

12. The method of claim 11, further comprising:
determining an estimated return time based on the location information of the guest device; and
switching the operating mode of the guest room to operate in a second mode prior to the estimated return time.

13. The method of claim 11, further comprising:
determining a service schedule for the guest room based on the estimated return time.

14. The method of claim 11, wherein the location information indicates that the guest device is at a specific venue.

15. The method of claim 11, wherein the location information indicates that the guest device is at a specific distance away from the hotel.

16. The method of claim 11, further comprising:
determining an estimated return time based on a movement of the guest device; and
switching the operating mode of the guest room to operate in a second mode prior to the estimated return time.

17. The method of claim 16, further comprising:
determining a service schedule for the guest room based on the estimated return time.

18. The method of claim 16, wherein the movement of the guest device indicates that the guest device is within the predetermined distance and moving in a direction towards the hotel.

19. The method of claim 11, wherein
determining whether the guest device is set to operate in a secure mode;
when the guest device is not operating in the secure mode, transmitting the unoccupied state of the guest room to both a hospitality device and a display device for displaying a room status; and
when the guest device is operating in the secure mode, transmitting the unoccupied state of the guest room only to the hospitality device among the hospitality device and the display device.

20. A computer apparatus, comprising:
a memory that stores instructions, and
a processor that executes the instructions,
wherein, when executed by the processor, the instructions cause the processor to perform operations comprising:
acquiring, from a guest device, a request for service;
storing, in a memory of the guest device, the request for service;
transmitting, to a server, the request for service;
extracting, by the server, a room number of a guest room corresponding to the request for service;
determining, by the server, a room status based on the request for service;
transmitting, to a display device, the extracted room number and the room status; and
controlling the display device to display the room status for the guest room.
